(19) United States
(12) Patent Application Publication
(10) Pub. No.: US 2018/0034038 A1
(43) Pub. Date: Feb. 1, 2018

(54) LEAD CARRIER STRUCTURE AND PACKAGES FORMED THEREFROM WITHOUT DIE ATTACH PADS

(71) Applicants: Philip E ROGREN, San Jose, CA (US); EOPLEX LIMITED, Hong Kong (CN)

(72) Inventor: Philip E ROGREN, San Jose, CA (US)

(73) Assignee: EOPLEX LIMITED, Hong Kong (CN)

(21) Appl. No.: 15/542,405

(22) PCT Filed: Jun. 3, 2016
(86) PCT No.: PCT/US2016/035844

§ 371 Date: Jul. 7, 2017

Related U.S. Application Data
(60) Provisional application No. 62/170,845, filed on Jun. 4, 2015.

(51) Int. Cl. H01M 4/04; H01M 10/0525; B33Y 80/00; H01M 4/74; H01M 4/75; H01M 10/0562; H01M 10/0585

(52) U.S. Cl. CPC H01M 4/0483; H01M 10/0562; H01M 10/0525; H01M 10/0585; H01M 4/74; H01M 4/75; B33Y 80/00; H01M 4/0471; H01M 4/0416

(57) ABSTRACT

A solid state electrochemical cell structure includes at least one integrated anode—current collector structure having a counterpart integrated cathode—current collector structure separated by an electrolyte layer. An integrated anode or cathode—current collector structure can be fabricated as a generally planar or planar layer structure having a surface area greater or much greater than its thickness, and which carries anode or cathode material composition, respectively, in which a current collector layer is enveloped, embedded, or encased; or a porous 3D mesh current collector structure in which an anode material composition or cathode material composition, respectively is enveloped, embedded, or encased by way of residing within a void volume fraction of the 3D mesh current collector structure. Integrated anode-current collector structures, cathode-current collector structures, and electrolyte layers can be fabricated by way of an additive manufacturing process (e.g., 3D printing).

### TECHNICAL FIELD

Aspects of the present disclosure are directed to solid state electrochemical cell fabrication techniques for producing solid state electrochemical cells having (i) an anode-current collector structure that includes an anode material containing, surrounding, or encasing a current collector material, or vice versa; and/or (ii) a cathode-current collector structure that includes a cathode material containing, surrounding, or encasing a current collector material, or vice versa. One or more portions of an anode-current collector structure and/or a cathode-current collector structure can be selectively or customizably fabricated by way of additive manufacturing (e.g., 3D printing).

### BACKGROUND

The vast majority of present day lithium ion battery cells are made of rolls or folded stacks of current collector sheets or layers. Current collectors are electron conductor materials (e.g., highly electrically conductive materials as a result of electron transport therein) that connect to the electrode terminals of the cell, and which (a) gather electrons from oxidation reactions, and (b) supply electrons for reduction reactions within the cell. More particularly, a first current collector sheet or layer is coated with anode materials or particles to thereby form an anode-current collector sheet or layer; and a second current collector sheet or layer is coated with cathode materials or particles to thereby form a cathode-current collector sheet or layer. In each of the anode-current collector sheet or layer and the cathode-current collector sheet or layer, the current collector sheet or layer itself is typically formed from metallic foil.

In each cell, the two electrode-current collector layers are separated from each other by a separator sheet or layer, which is typically formed of a polymer. Assemblies of electrode-current collector layers having separator sheets therebetween are inserted into a container, which typically has a cylindrical or box like configuration. Finally, the container is filled with an organic liquid electrolyte and sealed.

The container prevents liquid electrolyte leakage, and additionally serves to press the electrode-current collector layers together to ensure intimate contact between the electrode materials and the current collectors. Such a laminated structure is well-suited for high volume manufacturing, and works well with liquid electrolyte. However, the overall structure contains a significant percentage of material that does not contribute to energy storage, which unfortunately makes a battery significantly larger than desired.

In liquid electrolyte battery cells, much of the cell design is dictated by the liquid electrolyte. More particularly, since the electrolyte is a liquid, it must be sealed in some type of container or containment system in order to be retained therein. Additionally, liquid electrolytes for present day battery cells are organic solvents. During battery operation, metallic lithium in the cells reacts with water to form lithium hydroxide and hydrogen. The organic solvents and the hydrogen are highly flammable, and thus the container or containment system must be equipped with a safety vent mechanism to release gases that evolve during battery cycling.

Liquid electrolytes also unfortunately limit the maximum voltage that can be produced in the cell to approximately 3.5 to 4 volts.

The generally considered solution to the aforementioned drawbacks associated with liquid electrolytes is the use of solid electrolytes, which can be made stable to above 5 volts. However, conventional solid state electrolyte materials are typically ceramic materials, which (a) exhibit ionic conductivities significantly lower than liquid electrolytes; and (b) are rigid and brittle. As a result, solid state electrolyte layers separating the anode and cathode layers within the cell must be very thin to preserve a low internal resistance in the cell, as well as defect free. More particularly, a solid state electrolyte layer must be no more than 40 μm, and ideally much thinner, and it must be defect free to prevent dendritic growth of lithium metal that can short out the cell resulting in catastrophic failure of the cell, and substantial overheating at the point of the short. Because practical conventional solid state electrolytes are ceramic materials, they are rigid and strong in compression, but susceptible to impact or bending forces. This is particularly true for membranes only a few microns thick. The characteristics of ceramic solid state electrolyte materials make the manufacture of a solid state cell by way of conventional liquid electrolyte cell manufacturing techniques virtually impossible.

The generally anticipated or generally pursued manufacturing process for solid-state cells involves arranging or stacking (a) anode cell structures, each formed of a discrete anode material layer disposed adjacent to a corresponding anode current collector layer, and (b) cathode cell structures, each formed of a discrete cathode material layer disposed adjacent to a corresponding cathode current collector layer, on opposite sides of a solid state electrolyte membrane. Intimate and maximum area contact between all of the layers in the stack is critical to minimize the internal resistance of the cell, and since they are all discrete layers or sheets, some sort of clamping arrangement or structure that presses the layers into intimate contact is employed or necessary. Unfortunately, the addition of such a clamping structure will have a very negative impact on the specific energy capacity of the cell. Intimate contact between anode and cathode material layers can also be aided by an adhesive effect provided by a polymer electrolyte. However, polymer electrolytes have greater susceptibility to dendrite growth than ceramic electrolytes, and do not offer compatibility with lithium metal anode material.

The anode and cathode materials of rechargeable batteries, particularly those of the cathode materials, tend to be poor electron conductors. As a result, it is highly beneficial or essential to create a shortened or shortest possible average electron travel path between electrode materials and current collectors to minimize the internal resistance of the cell. Unfortunately, present solid state battery cell structures exhibit undesirably long electron travel paths between electrode materials and current collectors.

In addition to the foregoing, in most present solid state cell structures an undesirable amount of the total volume of the cell is occupied by structures or materials that do not directly contribute to ionic charge storage, thereby reducing the cell's capacity.

Certain attempts have been made to address at least some of the aforementioned shortcomings associated with solid state cell structures. For instance, one type of solid state battery cell structure is described by Young Jin Nam et al. in an article entitled “Bendable and Thin Sulfide Solid Electrolyte Film: A New Electrolyte Opportunity for Free-Standing and Stackable High-Energy All-Solid-State Lithium-Ion Batteries,” Nano Lett., 2015, 15(5), pp 3317-3323. This structure has a very thin layer of anode material, on top of which nickel-coated nanowires are randomly dispersed across the surface area of anode material layer as the anode current collector; a very thin layer of cathode material, below which nickel-coated nanowires are randomly dispersed across the surface area of the cathode material layer as the cathode current collector; and a very thin polymer electrolyte layer disposed between the anode material layer and the cathode material layer, where the polymer electrolyte layer includes nanowires randomly embedded therein for structural reinforcement purposes. Unfortunately, this design suffers from the drawbacks of a polymer electrolyte; and the energy density of this structure is 44 Wh/Kg, which is undesirably low, particularly compared to other types of cell designs that provide energy densities several times or even an order of magnitude greater. Additionally, the manner in which the nanowires are utilized in this type of cell structure does not lend itself well to high-volume automated production processes, including high-volume automated production processes by which different cell structures having distinct cell architectures can be readily produced in a highly customizable manner.

Another type of a solid state battery cell structure is described in U.S. Patent Publication No. 2013/0196235 utilizes a micron-scale porous 3D metal foam as its structural foundation, onto which a very thin layer of anode material is electrodeposited, further onto which a very thin layer of electrolyte is polymerized. A cathode material resides within the void spaces of the porous 3D metal foam, separated from the 3D metal foam by the very thin layer of polymer electrolyte and the very thin layer of electrodeposited anode material. This cell structure also appears to have undesirably limited energy density, as well as the drawbacks associated with a polymer electrolyte.

A need exists to solve the aforementioned drawbacks associated with existing solid state electrochemical cell manufacturing techniques, and the solid state electrochemical cells produced thereby.

### SUMMARY

Various embodiments in accordance with the present disclosure are directed to solid state electrochemical cell or battery cell fabrication techniques or processes, and associated solid state electrochemical cell or battery cell designs or structures that reduce or greatly reduce (e.g., to a near-minimum or minimum) the electron travel path between electrode materials and current collectors, thereby reducing or greatly reducing internal cell resistance; while simultaneously reducing or greatly reducing (e.g., to a near-minimum or minimum) the volume of an electrochemical cell occupied by electrochemical cell structures that do not contribute to ionic charge storage, such as portions of the electrochemical cell given over to current collectors and electrolyte.

A solid state electrochemical cell or battery cell manufacturing or fabrication process in accordance with an embodiment of the present disclosure can include or be an additive manufacturing process that provides the flexibility to selectively or selectably incorporate multiple types of materials into different portions of electrochemical cell structures fabricated by way of the process. A representative additive manufacturing process by which solid state electrochemical cells or battery cells can be fabricated in accordance with various embodiments of the present disclosure is described in U.S. Patent Publication 2015/0314530, which is incorporated herein by reference in its entirety. Additive manufacturing with the flexibility to selectively or selectably incorporate multiple distinct materials into different portions of fabricated structures brings a new level of freedom to the design of rechargeable battery cells, and enables the production of battery cells having enhanced volumetric and electrical efficiency. Depositing materials only where they are needed, such as by way of 3D printing, allows for reducing the volume of materials dedicated to current collection and the separation of anode and cathode material compositions or materials. At the same time, anode and cathode material compositions or materials can be selectively or selectably positioned within the cell in such a way as to reduce the electrical and ionic resistance within the cell.

In several embodiments, some or all components of a battery cell are formed or deposited as layers. Different layers can be of different design and/or composition, one to the next, such that the battery cell can include multiple constituent structures arranged or disposed in accordance with virtually any type of intended or required design, while maintaining the required structural relationships among or between the battery cell constituent structures for battery cell operation. In such embodiments, different layers can be deposited sequentially in an additive manufacturing process, for instance, a 3D printing process that includes multiple distinct 3D printing procedures, where the particular configuration of the printed layers is determined or developed directly from a digital representation of a corresponding battery cell structure design.

Some representative embodiments of battery cell structures in accordance with the present disclosure include current collectors deposited as a fine wire network, mesh, or grid distributed within the layers of electrode materials. Such a structure can be fabricated by way of a multi-materials 3D printing process such as that described in U.S. Patent Publication 2015/0314530, where the electrode materials can be deposited multiple successive layers, where at least one of a plurality of electrode layers contains, impregnated within it, a fine wire network of electronically conductive or electron conductor material that forms portions of or which serves as a current collector. The fine wire network can also be created as part of the multi-materials 3D printing process. In such embodiments, the fine wire network is typically thinner than the electrode material layer in which it is contained, and is designed such as to reduce or optimize the average distance from any location within the electrode material to the nearest location on the fine wire network, while simultaneously minimizing the volume of the fine wire network.

When the total volume of the electrode material is deposited as multiple 3D printed layers, each electrode material layer can contain an identical fine wire network, or some layers can be devoid of electron conductor material (e.g., a fine wire network). Additionally or alternatively, one or more layers can contain a primary fine wire network as well as a complementary fine wire network electrically coupled thereto for further reducing or optimizing ratio of the average distance from the electrode material to electron conductor material, relative to the volume that the electron conductor occupies within the electrode material.

In other representative embodiments of battery cell structures in accordance with the present disclosure, a current collector includes or is formed as a porous 3D scaffold or mesh of electron conducting material having voids, passages, or channels therein that provide or define a void or porous volume fraction of the 3D mesh relative to an overall spatial volume of the 3D mesh (e.g., as defined by the overall dimensions of the 3D mesh along orthogonal x, y, and z axes). The 3D mesh can be fabricated in multiple manners, including by way of a 3D printing process, in a manner readily understood by individuals having ordinary skill in the relevant art. A flowable electrode material composition carrying an electrode material is introduced or impregnated into the 3D mesh, after which the electrode material composition therein is densified such that it rigidifies or is no longer flowable, and the electrode material remains distributed within or throughout the voids, passages, or channels of the 3D mesh (e.g., the densified electrode material composition occupies nearly all or essentially all of the void or porous volume fraction of the 3D mesh).

Various electrochemical cell structures or battery cell structures fabricated in accordance with embodiments of the present disclosure can be based on Lithium ion types of chemistries. Notwithstanding, fabrication processes and corresponding structures fabricated thereby in accordance with embodiments of the present disclosure are applicable to other chemistries, as will be readily understood by individuals having ordinary skill in the relevant art.

In accordance with an aspect of the present disclosure, an electrochemical cell structure includes
at least one electrochemical cell, each electrochemical cell having: a plurality of integrated electrode-current collector structures, each integrated electrode-current collector structure carrying an electrode material therein, the plurality of integrated electrode-current collector structures including a first integrated electrode-current collector structure carrying a first electrode material therein, and an electrical or electrochemical counterpart second integrated electrode-current collector structure carrying a distinct second electrode material therein, the first and second integrated electrode-current collector structures including: (a) an electrode material composition layer carrying the first electrode material or the second electrode material, respectively, the electrode material composition layer having a planar surface area greater than a thickness of the electrode material composition layer; and a current collector layer comprising a current collector for the first integrated electrode-current collector structure or the second integrated electrode-current collector structure, respectively, the current collector layer disposed internal to and surrounded by the electrode composition layer; or (b) a 3D current collector material mesh structure comprising the current collector for the first integrated electrode-current collector structure or the second integrated electrode-current collector structure, respectively, the 3D current collector mesh structure having voids therein that provide a void volume fraction of the 3D current collector material mesh structure, wherein the first electrode material or the second electrode material, respectively, is distributed within or throughout the void volume fraction of the 3D current collector material mesh structure; and an electrolyte layer separating the first integrated electrode-current collector structure from its counterpart second integrated electrode-current collector structure and providing an ionic charge transport medium between the first integrated electrode-current collector structure and its counterpart second integrated electrode-current collector structure, wherein the first integrated electrode-current collector structure includes or is one of an integrated anode-current collector structure and an integrated cathode-current collector structure, and the second electrode-current collector structure includes or is the other of the integrated anode-current collector structure and the integrated cathode-current collector structure.

The electrochemical cell structure can include a plurality of electrochemical cells stacked adjacent to each other, for instance, as a plurality of 3D printed structures. The first electrode material can include or be a powder based anode material, and the second electrode material can include or be a powder based cathode material. The electrolyte layer can include or be a ceramic material, and can also be a planar layer having a surface area that is greater than its thickness.

The plurality of integrated electrode-current collector structures can include: an integrated anode-current collector structure comprising an anode material composition layer having a thickness, and an anode current collector layer disposed internal to and surrounded by the thickness of the anode material composition layer; and a counterpart integrated cathode-current collector structure comprising a cathode material composition layer having a thickness, and a cathode current collector layer disposed internal to and surrounded by the thickness of the cathode material composition layer. At least one of the anode current collector layer and the cathode current collector layer ca include or be a planar or quasi-2D layer of material, such as a network of wire elements organized in accordance with a predetermined or selectable wire element pattern.

The plurality of integrated electrode-current collector structures can include or be a plurality of stacked electrochemical cells, each electrochemical cell within the stack having: a 3D mesh integrated anode-current collector structure comprising a first 3D current collector material mesh structure having voids therein that provide a first void volume fraction, and having an anode material distributed within or throughout the first void volume fraction; and a 3D mesh integrated cathode-current collector structure comprising a second 3D current collector material mesh structure having voids therein that provide a second void volume fraction, and having a cathode material distributed within or throughout the second void volume fraction. The 3D mesh integrated anode-current collector structure excludes the cathode material, and wherein 3D mesh integrated cathode-current collector structure excludes the anode material. Each of the 3D mesh integrated anode-current collector structure and the 3D mesh integrated cathode current collector structure can include or be a sinterable material.

In accordance with an aspect of the present disclosure, a process for manufacturing a set of electrochemical cell structures is disclosed, wherein each electrochemical cell structure is manufactured by way of: producing a first integrated electrode-current collector structure carrying a first electrode material therein by way of a first additive manufacturing process; producing an electrolyte layer disposed on an exposed surface of the first integrated electrode-current collector structure by way of a second additive manufacturing process; and producing a second integrated electrode-current collector structure carrying a distinct second electrode material therein on an exposed surface of the electrolyte layer by way of a third additive manufacturing process, wherein the first and second integrated electrode-current collector structures have: (a) an electrode material composition layer carrying the first electrode material or the second electrode material, respectively, the electrode material composition layer having a planar surface area that is greater than a thickness of the electrode material composition layer; and a current collector layer comprising a current collector for the first integrated electrode-current collector structure or the second integrated electrode-current collector structure, respectively, the current collector layer disposed internal to and surrounded by the electrode composition layer; or (b) a 3D current collector material mesh structure comprising the current collector for the first integrated electrode-current collector structure or the second integrated electrode-current collector structure, respectively, the 3D current collector mesh structure having voids therein that provide a void volume fraction of the 3D current collector material mesh structure, wherein the first electrode material or the second electrode material, respectively, is distributed within or throughout the void volume fraction of the 3D current collector material mesh structure, wherein the electrolyte layer separates the first integrated electrode-current collector structure from its counterpart second integrated electrode-current collector structure, and the electrolyte layer provides an ionic charge transport medium between the first integrated electrode-current collector structure and its counterpart second integrated electrode-current collector structure.

The second additive manufacturing process can include fabricating an electrolyte layer on the exposed surface of the first integrated electrode-current collector structure, wherein the electrolyte layer comprises a ceramic electrolyte material. Each of the first, second, and third additive manufacturing processes can include or be a 3D printing process. The first integrated electrode-current collector structure, the electrolyte layer, and the second integrated electrode-current collector structure can each include or be a set of planar layers having a surface area greater than a thickness thereof.

Manufacturing each electrochemical cell structure can include: producing by way of the first additive manufacturing process an integrated anode-current collector structure comprising an anode material composition layer having a thickness, and an anode current collector layer disposed internal to and surrounded by the thickness of the anode material composition layer; and producing by way of the third additive manufacturing process a counterpart integrated cathode-current collector structure comprising a cathode material composition layer having a thickness, and a cathode current collector layer disposed internal to and surrounded by the thickness of the cathode material composition layer.

At least one of the first additive manufacturing process and the third additive manufacturing process comprises fabricating the current collector layer as quasi-2D layer of material, for instance, a quasi-2D network of current collector wire elements organized in accordance with a predetermined or selectable current collector wire element pattern.

Manufacturing each electrochemical cell structure can include: producing by way of the first additive manufacturing process a first 3D mesh structure comprising a first current collector material having voids therein that provide a first void volume fraction; distributing an anode material within or throughout the first void volume fraction of the 3D mesh structure to thereby form a 3D mesh integrated anode-current collector structure; producing by way of the third additive manufacturing process a second 3D mesh structure comprising a second 3D current collector material having voids therein that provide a second void volume fraction; and distributing a cathode material within or throughout the second void volume fraction of the 3D mesh integrated cathode-current collector structure to thereby form a 3D mesh integrated cathode-current collector structure. The first void volume fraction can be 50%-99.8% of the overall spatial volume of the first 3D mesh structure, and the second void volume fraction can be 50%-99.8% of the overall spatial volume of the second 3D mesh structure. The 3D mesh integrated anode-current collector structure excludes the cathode material, and the 3D mesh integrated cathode-current collector structure excludes the anode material. Each of the 3D mesh integrated anode-current collector structure and the 3D mesh integrated cathode-current collector structure can include or be a sinterable material.

### BRIEF DESCRIPTION OF THE DRAWINGS

FIG. 1 is a cross sectional perspective illustration of a portion of an electrochemical cell produced by way of an electrochemical cell fabrication process in accordance with embodiment of the present disclosure.

FIGS. 2A-2C are illustrations of current collector portion 3D mesh structures in accordance with particular representative embodiments of the present disclosure.

FIG. 2D illustrates portions of a representative multi-layer 3D mesh current collector based electrochemical or battery cell structure in accordance with an embodiment of the present disclosure.

FIG. 3 is a flow diagram illustrating aspects of a representative multi-materials 3D manufacturing process in accordance with the present disclosure, by which particular electrochemical or battery cell structures can be fabricated.

### DETAILED DESCRIPTION

In the present disclosure, the depiction of a given element or consideration or use of a particular element number in a particular FIG. or a reference thereto in corresponding descriptive material can encompass the same, an equivalent, or an analogous element or element number identified in another FIG. or descriptive material associated therewith. The presence of “/” in a FIG. or text herein is understood to mean “and/or” unless otherwise indicated. The recitation of a particular numerical value or value range herein is understood to include or be a recitation of an approximate numerical value or value range, for instance, within +/−20%, +/−15%, +/−10%, +/−5%, +/−2%, or +/−0%. The term “essentially all” can indicate a percentage greater than or equal to 90%, for instance, 95%, 98%, 99%, or 100%.

As used herein, the term “set” corresponds to or is defined as a non-empty finite organization of elements that mathematically exhibits a cardinality of at least 1 (i.e., a set as defined herein can correspond to a unit, singlet, or single element set, or a multiple element set), in accordance with known mathematical definitions (for instance, in a manner corresponding to that described in An Introduction to Mathematical Reasoning: Numbers, Sets, and Functions, “Chapter 11: Properties of Finite Sets” (e.g., as indicated on p. 140), by Peter J. Eccles, Cambridge University Press (1998)). In general, an element of a set can include or be a system, an apparatus, a device, a structure, an object, a process, a physical parameter, or a value depending upon the type of set under consideration.

Overview

Embodiments in accordance with the present disclosure are directed to (a) techniques or processes for fabricating, manufacturing, or producing solid state electrochemical cells or battery cells (e.g., lithium ion battery cells); and (b) various types of solid state electrochemical cell structures and/or corresponding battery cell structures that can be produced in accordance with such techniques. A solid state electrochemical cell or battery cell fabrication process in accordance with the present disclosure can be include or be based on one or more additive manufacturing processes or procedures, such as a 3D printing process described in U.S. patent publication 2015/0314530 and/or another type of process or procedure, in association with or by which one or more electrodes or electrode elements can be fabricated as integrated electrode-current collector structures in accordance with particular embodiments of the present disclosure.

A given integrated electrode-current collector structure includes an electrode composition portion that carries or provides an electrode material composition or material; and a current collector portion that includes or provides a current collector material composition or material. Depending upon embodiment details, the electrode composition portion can contain, enclose, surround, encase, or encapsulate the current collector portion; or the current collector portion can contain, enclose, surround, encase, or encapsulate the electrode composition portion. More particularly, an integrated electrode-current collector structure can include an electrode material composition or material that contains, encloses, surrounds, encases, or encapsulates a current collector material composition or material; or a current collector material composition or material that contains, encloses, surrounds, encases, or encapsulates an electrode material composition or material.

Some solid state electrochemical cell embodiments in accordance with the present disclosure include both anodes or anode elements as well as cathodes or cathode elements that are formed as integrated anode-current collector structures and integrated cathode-current collector structures, respectively. In other embodiments, anode elements are formed as integrated anode-current collector structures, while cathode elements are formed as conventional cathode elements or structures; or cathode elements are formed as integrated cathode-current collector structures, while anode elements are formed as conventional anode elements or structures.

Further to the foregoing, several embodiments of solid state electrochemical cell structures fabricated in accordance with the present disclosure include (i) at least one integrated anode-current collector structure in which an anode composition portion contains, encloses, surrounds, encases, or encapsulates a current collector portion, or vice versa; and/or (ii) at least one integrated cathode-current collector structure in which a cathode composition portion contains, encloses, surrounds, encases, or encapsulates a current collector portion, or vice versa; as well as (iii) a solid state electrode structure or composition disposed between each anode-current collector structure and its counterpart cathode-current collector structure (e.g., its electrical/electrochemical counterpart structure).

In integrated anode-current collector structure embodiments in which the anode composition portion contains the current collector portion, the anode composition portion can include or be formed as a patterned or unpatterned non-planar, planar, approximately planar, or generally planar anode composition layer structure that carries or provides an anode material therein; and the current collector portion can include or be formed as a layer, pattern, network, matrix, mesh, fabric, lattice, web, screen, grid, or mat of current collector material disposed within the thickness of the anode composition layer structure. For instance, in such embodiments, the anode composition layer structure can include a first or underlying anode composition layer; a current collector mesh disposed on top of the first anode composition layer; and a second or overlying anode composition layer disposed above the current collector mesh and the first anode composition layer. Each anode composition layer and/or the current collector mesh can be formed or deposited by way of an additive manufacturing process or procedure, such as a 3D printing procedure.

Alternatively, in integrated anode-current collector structure embodiments in which the current collector portion contains the anode composition portion, the current collector portion can include or be formed or structured as a 3D mesh, scaffold, cellular solid (e.g., a sponge or foam type structure, such as a metallic foam structure), skeleton, cage, matrix, or lattice structure that includes, provides, or is formed of a current collector material, and which has pores, apertures, and voids, gaps, passages, and/or channels therein that provide a significant amount of available void space or unoccupied internal volume relative to the current collector portion's overall 3D spatial dimensions; and the anode composition portion can include or be a flowable and densifiable or curable material composition that carries or provides an anode material therein, which is introduced into the current collector portion's pores, apertures, and voids, gaps, passages, or channels such that it occupies or fills nearly all or essentially all of the current collector portion's internal void space (i.e., the internal volumetric fraction of the current collector portion provided by the pores, apertures, and voids, gaps, passages, or channels, which can be referred to the void or porous volume fraction of the as-fabricated current collector portion). In such embodiments, the current collector portion can be formed by way of an additive manufacturing process or procedure such as a 3D printing procedure, or another type of process or procedure in a manner readily understood by individuals having ordinary skill in the art.

In a manner analogous to that set forth above, in integrated cathode-current collector structure embodiments in which the cathode composition portion contains the current collector portion, the cathode composition portion can include or be formed or structured as a patterned or unpatterned non-planar, planar, approximately planar, or generally planar cathode composition layer structure that carries or provides a cathode material therein; and the current collector portion can be formed or structured as a layer, pattern, network, matrix, mesh, fabric, lattice, web, screen, grid, or mat of current collector material disposed within the thickness of the cathode composition layer structure. For instance, in such embodiments, the cathode composition layer structure can include a first or underlying cathode composition layer; a current collector mesh disposed on top of the first cathode composition layer; and a second or overlying cathode composition layer disposed above the current collector mesh and the first cathode composition layer. Each cathode composition layer and/or the current collector mesh can be formed or deposited by way of an additive manufacturing process or procedure, such as a 3D printing procedure.

Alternatively, in integrated cathode-current collector structure embodiments in which the current collector portion contains the cathode composition portion, the current collector portion can include or be formed or structured as a 3D mesh, scaffold, cellular solid (e.g., an open cell or closed cell sponge or foam type structures, such as a metallic foam structure), skeleton, cage, matrix, or lattice structure that includes, provides, or is formed of a current collector material, and which has pores, apertures, and voids, gaps, passages, or channels therein that provide a significant amount of available void space or unoccupied internal volume relative to the current collector portion's overall 3D spatial dimensions; and the cathode composition portion can include or be a flowable and densifiable or curable material composition that carries or provides a cathode material therein, which is introduced into the current collector portion's pores, apertures, and voids, gaps, passages, or channels such that it occupies or fills nearly all, essentially all, or all of the current collector portion's void or porous volume fraction. In such embodiments, the current collector portion can be formed by way of an additive manufacturing process or procedure such as a 3D printing procedure, or another type of process or procedure in a manner readily understood by individuals having ordinary skill in the art.

Representative Integrated Electrode-Current Collector Structures

A. Embodiments in which Electrode Composition Portions Contain Current Collector Portions

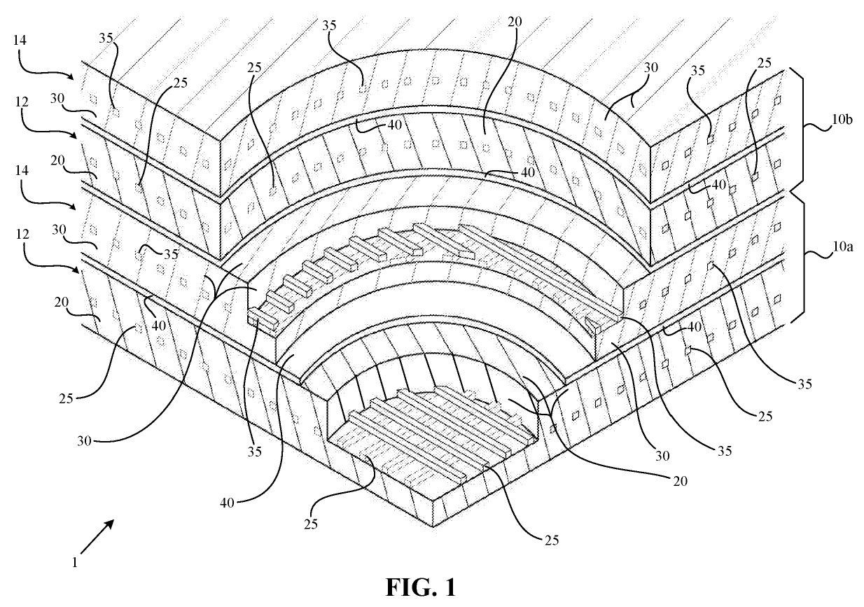

FIG. 1 is a cross sectional perspective view showing portions of a multi-layer electrochemical cell or battery cell structure 1 in accordance with a representative embodiment of the present disclosure, which includes a first layer 10a and a second layer 10b, each of which forms or constitutes an individual or complete electrochemical cell. While the embodiment shown in FIG. 1 is depicted as having two layers 10a,b, individuals having ordinary skill in the art will understand that other embodiments can have a different number of layers, for instance, a single layer 10 or more than two layers 10a,10b. Layers 10a,b can be arranged in a sequential, serial, side-by-side, or stacked manner, such that a largest surface area portion (e.g., a largest planar surface area) of each layer 10a is disposed on a largest surface area portion (e.g., a largest planar surface aera) of an adjacent layer 10b.

Each layer 10a,b carries electrode materials that by themselves do not have sufficient electron conductivity to meet the performance objectives of the electrochemical cell structure. Consequently, each layer 10a,b includes an integrated anode-current collector structure 12 and an integrated cathode-current collector structure 14. In various embodiments, the integrated anode-current collector structure 12 and the integrated cathode-current collector structure 14 are generally planar, substantially planar, approximately planar or planar layer structures, having approximately planar or planar surface areas that exceed or greatly exceed (e.g., by at least a few or several multiples) the thicknesses of the integrated anode-current collector structure 12 and the integrated cathode-current collector structure 14, respectively. In a number of embodiments, the integrated anode-current collector structure 12 and the integrated cathode-current collector structure 14 can each have an identical or essentially identical planar surface area (e.g., corresponding to an x-y plane, where a z axis direction is defined as vertical).

The integrated anode-current collector structure 12 includes an anode composition portion formed as an anode composition layer or a set of anode composition layers 20 (e.g., formed as at least one approximately planar or planar layer structure), plus an anode current collector portion 25 disposed therein; and the integrated cathode-current structure 14 includes a cathode composition portion formed as a cathode composition layer or a set of cathode composition layers 30 (e.g., formed as at least one approximately planar or planar layer structure), plus a cathode current collector portion 35 disposed therein. The anode composition layer 20 carries an anode material composition or anode material, and the composition layer 30 carries a cathode material composition or cathode material, as further detailed below. The anode composition layer 20 and the cathode composition layer 30 each have a target, intended, or predetermined thickness, as also detailed below.

The anode current collector portion or anode current collector 25 and the cathode current collector portion or cathode current collector 35 reside within the thickness of the anode composition layer 20 and the cathode composition layer 30, respectively (e.g. the anode or cathode current collector 25, 35 can form a layer or sub-layer of current collector material disposed at least partially within the thickness or interior of and at last partially surrounded, enclosed, or encapsulated by the anode composition layer 20 or the cathode composition layer 30, respectively). Depending upon embodiment details, the anode current collector 25 and/or the cathode current collector 35 can each be formed as an unpatterned or patterned layer, such as a generally planar, approximately planar, planar or quasi-2D layer of current collector material, for instance, a continuous or discontinuous planar or quasi-2D sheet or a quasi-2D network, mesh, lattice, or grid (hereafter referred to as a 2D mesh) of electron conductor elements such as wires. In some embodiments, the anode current collector 25 and the cathode current collector 35 can each include or be a quasi-2D wire network in a manner shown in FIG. 1 (e.g., a network of wire elements organized or defined in accordance with a predetermined or selectable wire element layout or pattern). Such a planar or quasi-2D layer of current collector material reduces, greatly reduces, or nearly minimizes the average resistance between points or locations within (a) the anode composition layer 20 and the anode current collector portion 25; and (b) the cathode composition layer 30 and cathode current collector portion 35. In other embodiments, the anode current collector portion 25 and/or the cathode current collector portion 35 can include or be a very thin 3D scaffold or mesh structure, or a very thin 3D network of wire filaments, distributed within or throughout the volume of the anode composition layer 20 and/or the cathode composition layer 30, respectively. In a number of embodiments, a distance between each of a first largest surface area side and an opposite or opposing second largest surface area side of the anode composition layer 20 to the anode current collector 25 can be identical (e.g., the anode current collector 25 can be disposed at a middle region or approximate midpoint of the anode composition layer's thickness); and/or a distance between each of a first largest surface area side and an opposite or opposing second largest surface area side of the cathode composition layer 30 to the cathode current collector 35 can be identical (e.g., the cathode current collector 35 can be disposed at a middle region or approximate midpoint of the cathode composition layer's thickness).

Each anode layer 20 is separated from an adjacent or counterpart cathode layer 35 by an electrolyte portion or layer 40 that includes or is formed of a very thin layer of electrolyte material, such that an anode layer 20 and its adjacent cathode layer 35 constitute a complete electrochemical cell, in a manner readily understood by individuals having ordinary skill in the relevant art. The electrolyte layer 40 has a target, intended, or predetermined thickness, as further described below, and in various embodiments includes or is a planar or approximately planar layer, e.g., the electrolyte layer 40 has a planar surface area that is greater or much greater than its thickness.

In another embodiment (not shown), an electrochemical cell structure or battery cell structure 1 includes a first electrode or electrode structure having an integrated anode-current collector structure 20 or an integrated cathode-current collector structure 30, in which an anode material composition or cathode material composition, respectively, having poor electron conductivity is integrated with a current collector portion 25, 35, for instance, in a manner analogous, essentially identical, or identical to that described with reference to FIG. 1; while an opposing or counterpart second electrode or electrode structure includes a cathode or anode material, respectively, having a sufficiently high or high electron conductivity to meet the design requirements of the cell. In such an embodiment, the second electrode structure need not have or does not require a current collector portion 25, 35. In other words, the second electrode structure includes an anode material or a cathode material that itself exhibits or provides sufficiently high electron conductivity that a distinct current collector portion 25, 35 can be omitted, in a manner readily understood by individuals having ordinary skill in the relevant art. For instance, such a sufficiently or highly conductive anode material can include or be lithium metal, and a sufficiently or highly conductive cathode material can include or be lithium cobalt oxide loaded with a conductive phase such as carbon or graphite.

B. Embodiments in which Current Collector Portions Contain Electrode Composition Portions

In some embodiments, the current collector portion of an integrated electrode-current collector structure contains the electrode composition portion of the integrated electrode-current collector structure. More particularly, the current collector portion of an integrated electrode-current collector structure can include or be a porous 3D mesh, scaffold, cellular solid, skeleton, cage, lattice, or similar type of structure that carries or is made of a current collector material, and which has apertures or openings and void or empty spaces, gaps, passages, channels, and/or chambers distributed therein. A flowable substance or material composition having a target or predetermined viscosity and which carries an electrode material (i.e., an anode material or a cathode material) can be introduced, impregnated, or diffused into the void spaces within such a 3D mesh structure, and subjected to a densification or curing process to provide the electrode composition portion of the integrated electrode - current collector structure within the void or porous volume fraction of the 3D mesh structure. Various types of 3D mesh structures suitable for use as current collector portions in embodiments in accordance with the present disclosure can be fabricated by way of a 3D printing and/or other type of process, as will be readily understood by individuals having ordinary skill in the relevant art.

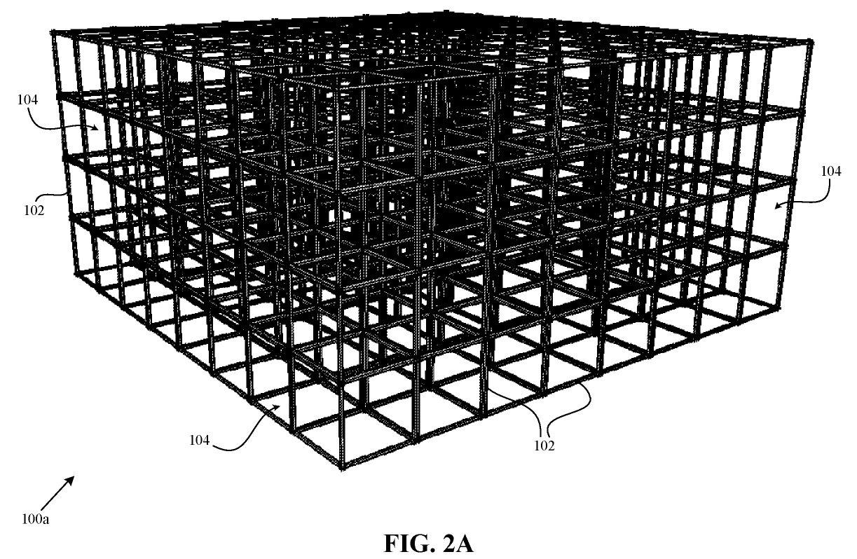

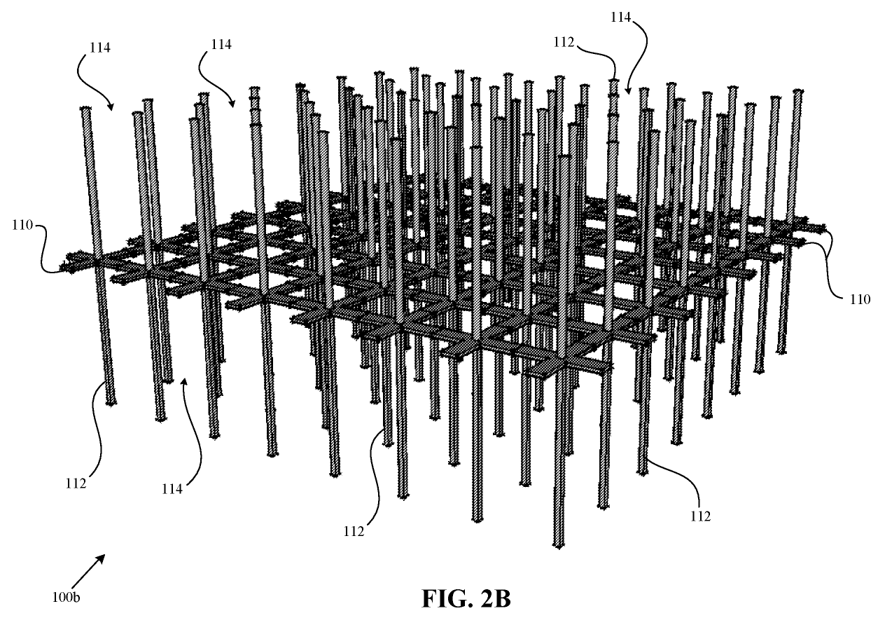

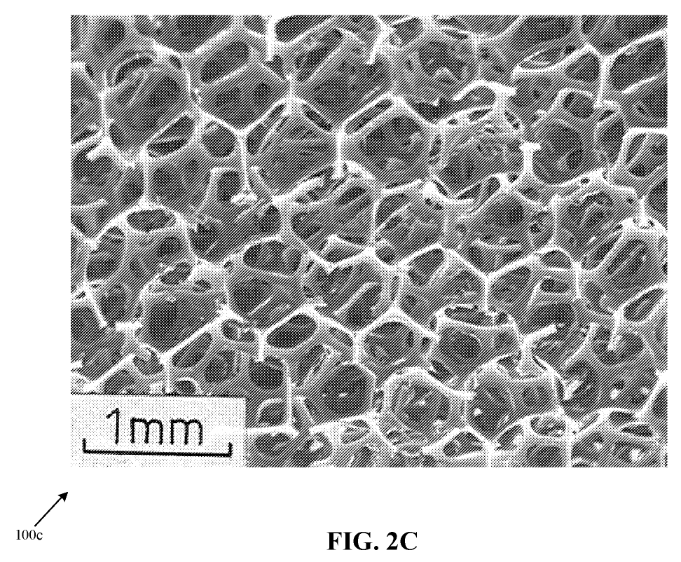

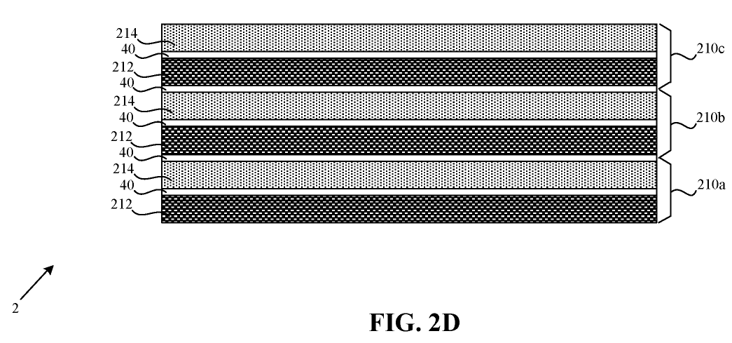

FIGS. 2A-2C are illustrations of current collector portion 3D mesh structures or 3D current collector mesh structures 100a-c in accordance with particular representative embodiments of the present disclosure. More particularly, FIG. 2A illustrates a first frame structure 100a formed as an (x, y, z) grid of frame members or wires 102 to define a cubic lattice, where the frame members 102 carry or are formed of an electron conductor material. The frame members 102 are electrically coupled 102 to each other, and frame members 102 can further be electrically coupled to a battery cell terminal in a manner readily understood by individuals having ordinary skill in the relevant art. Such an organization of frame members 102 establishes a plurality of internal compartments or cells 104 within the frame structure 100a. Each individual cell 104 has a void space therein, and the cells 104 are configured for fluid communication between their void spaces. A flowable and densifiable or curable anode material composition or cathode material composition can be introduced, impregnated, or diffused into the internal cells 104. After densification or curing, the anode material composition or cathode material composition remains within the cells 104, occupying nearly all or essentially all of the void volume fraction of the first frame structure 100a and providing the anode composition portion or cathode composition portion of an integrated anode-current collector structure or integrated cathode-current collector structure, respectively. While the 3D mesh current collector structure 100a of FIG. 2A is shown as having a regular cubic structure, individuals having ordinary skill in the art will recognize that a 3D mesh current collector structure 100 in accordance with an embodiment of the disclosure can correspond to or exhibit another type of polyhedral shape. Individuals having ordinary skill in the relevant art will also understand that the cells 104 of a 3D mesh current collector structure 100 can exhibit non-rectangular cross-sectional areas (e.g., hexagonal or octagonal cross-sectional areas).

FIG. 2B illustrates a second frame structure 100b having a network or array of wires 112 extending along a predetermined axial direction, and at least one support grid 110 formed transverse or perpendicular to this axial direction, such that the wires 112 within the network extend on opposite sides of the support grid 110. The wires 112 and typically the support grid 110 carry or are formed of an electron conductive material, and the wires and typically the support grid 110 are electrically coupled to each other. The wires 112 and possibly the support grid 110 can further be electrically coupled to a battery cell terminal in a manner readily understood by individuals having ordinary skill in the relevant art. Separations, spaces, or gaps 114 exist between the wires 112, such that a flowable and densifiable or curable anode material composition or cathode material composition can be introduced, impregnated, or diffused into the gaps 114. After densification or curing, the anode material composition or cathode material composition remains within the gaps 114, occupying nearly all or essentially all of the void volume fraction of the second frame structure 100b and providing the anode composition portion or cathode composition portion of an integrated anode-current collector structure or integrated cathode-current collector structure, respectively.

FIG. 2C illustrates a 3D porous mesh structure 100c, which includes a generally irregular or irregular network of interconnected thin strand-like segments of electron conductor material with voids between the strand-like segments, such as in a 3D mesh, scaffold, foam, or sponge type structure, in a manner readily understood by individuals having ordinary skill in the relevant art. The strand-like segments carry or are formed of an electron conductive material, and are electrically coupled to each other within the 3D porous mesh structure, and can further be electrically coupled to a battery cell terminal in a manner readily understood by individuals having ordinary skill in the relevant art. A flowable and densifiable or curable anode material composition or cathode material composition can be introduced, impregnated, or diffused into the voids of the 3D porous mesh structure 100c. After densification or curing, the anode material composition or cathode material composition remains within the voids, occupying nearly all or essentially all of the void volume fraction of the 3D porous mesh structure 100c and providing the anode composition portion or cathode composition portion of an integrated anode-current collector structure or integrated cathode-current collector structure, respectively.

FIG. 2D illustrates portions of a representative multi-layer 3D mesh current collector based electrochemical or battery cell structure 2 in accordance with an embodiment of the present disclosure, which includes a first layer 210a, a second layer 210b, and a third layer 210c, each of which forms or constitutes an individual or complete electrochemical cell. While the embodiment shown in FIG. 2 is depicted as having three layers 210a-c, individuals having ordinary skill in the art will understand that other embodiments can be formed as a different number of layers, for instance, a single layer 210, two layers 210a,b, or more than three layers 210a-c depending upon embodiment details.

Each layer 210a,b includes a 3D mesh integrated anode-current collector structure 212 and a 3D mesh integrated cathode-current collector structure 214, where the 3D mesh anode-current collector structure 212 includes or is formed as a first 3D current collector mesh structure 100 (e.g., in a manner indicated in FIGS. 2A-2C) that carries or contains an anode material therein (e.g., which is distributed throughout the void volume fraction of this 3D current collector mesh structure 100); and the 3D mesh cathode-current collector structure 214 includes or is formed as a second 3D current collector mesh structure 100 (e.g., in a manner indicated in FIGS. 2A-2C) that carries or contains a cathode material therein (e.g., which is distributed throughout the void volume fraction of this 3D current collector mesh structure 100).

C. Further Embodiments

Some embodiments of an electrochemical or battery cell structure in accordance with the present disclosure can include one or more integrated electrode-current collector structures (e.g., a first integrated electrode-current collector structure) formed in a manner such as that shown in FIG. 1, in which an anode portion 12 or a cathode portion 14 respectively contains an anode current collector portion 25 or cathode current collector portion 35; as well as one or more integrated electrode-current collector structures (e.g., a second electrode-current collector structure) formed in a manner such as that indicated in FIGS. 2A-2C, in which a 3D mesh current collector portion 100 contains an anode material or cathode material therein. Anode and cathode portions of the electrochemical or battery cell structure are separated or segregated by a set of electrolyte layers 40, in a manner readily understood by individuals having ordinary skill in the relevant art.

Representative Integrated Electrode-Current Collector Manufacturing Processes

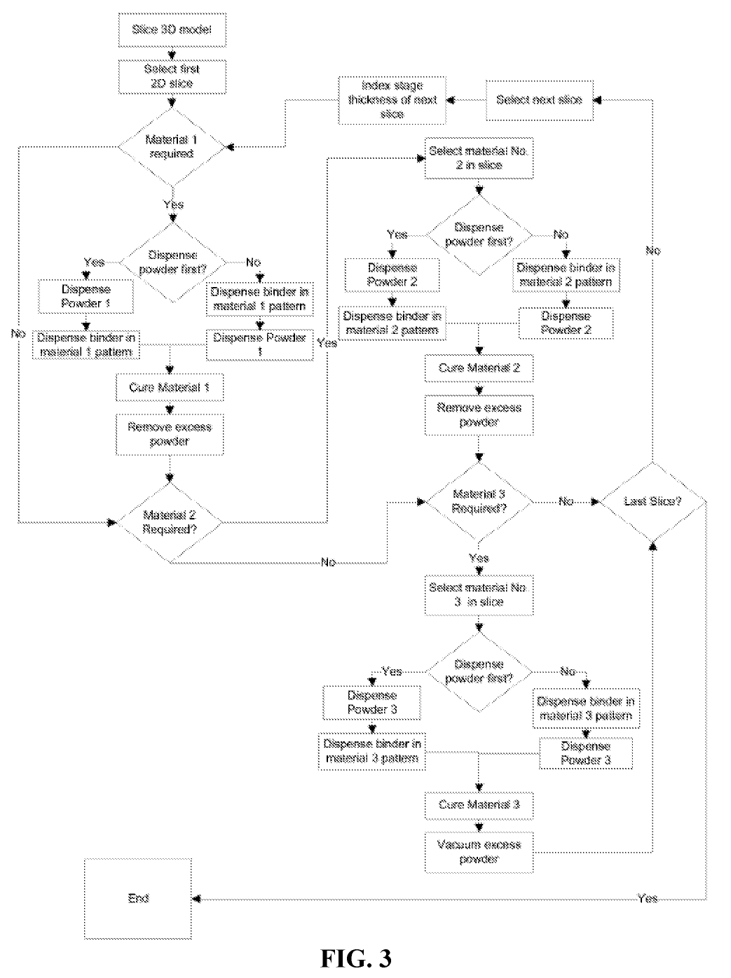

Portions of a solid state electrochemical cell or solid state battery cell in accordance with an embodiment of the present disclosure can be manufactured by way of one or more manufacturing processes or procedures, for instance, a multi-materials additive manufacturing process described in U.S. Patent Publication 2015/0314530 and/or another type of process or procedure. For instance, by way of a process described in U.S. Patent Publication 2015/0314530, successive layers of a solid state electrochemical cell structure or solid state battery cell structure 1 such as that shown in FIG. 1 can be produced by way of successively or sequentially and selectively or selectably dispensing and layering powders containing (a) one or more types of anode materials and one or more types of electron conductor materials to form a set of anode-current collector portions 12; (b) one or more types of electrolyte materials to form a set of electrolyte layers 40; and (c) one or more types of cathode materials and one or more types of electron conductor materials to form a set of cathode-current collector portions 14 of the cell. Such powders can be dispensed across a two dimensional area in accordance with a programmably specified pattern, for instance, as continuous sheets or patterned sheets to produce an electrochemical or battery cell structure 1 in accordance with an intended or desired electrochemical or battery cell architecture or design (e.g., a digital 3D electrochemical cell or battery cell structure model). A given layer of powder(s) can be dispensed over a build plate, and binder can be selectively applied to hold particular portions of the layer together, after which unbound powder(s) can be removed. Binder materials can be subjected to a curing process or procedure to accelerate binding of powder(s) together in a layer under consideration. FIG. 3 is a flow diagram illustrating aspects of a representative multi-materials 3D manufacturing process in accordance with the present disclosure, by which particular electrochemical or battery cell structures can be fabricated.

Further to the foregoing, a 3D mesh current collector structure 100 in accordance with an embodiment of the present disclosure can also be fabricated by a multi-materials 3D manufacturing process such as that described in U.S. Patent Publication 2015/0314530. More particularly, voids can be formed within portions of a layer by incorporating or dispensing a fugitive or sacrificial material therein, which can be selectively removed from the layer in a subsequent process portion (e.g., a heating/sintering process portion), for instance, such that the 3D mesh current collector structure has a void volume fraction between approximately 50%-99.8%. Moreover, a flowable organic vehicle, medium, or substance including monomers and oligomers selected to provide an intended or desired thixotropic rheology with a viscosity consistent with the actual sizes of the voids can be used to carry one or more anode materials or one or more cathode materials dispersed therein. The anode or cathode material(s) can be extruded into the porous 3D mesh current collector structure 100 in one or more manners, such as by screen or stencil printing, doctor blading. Alternatively, the anode or cathode material(s) can be incorporated into the porous 3D mesh current collector structure 100 by way of vacuum-assisted diffusion. A 3D mesh current collector structure 100 having anode or cathode powder(s) distributed within or throughout its void spaces can be densified in a single heat treating process or procedure that decomposes and volatilizes organic vehicle materials and sinters inorganic materials into a solid integrated structure.

As another alternative, the anode or cathode material(s) can be formulated into highly flowable powders and dispersed into the 3D mesh current collector structure 100 with a powder dispersion/compaction system corresponding to or based on a powder bed 3D printer, and the powder(s) can be fixed in desired locations by way of a computer controlled binder jetting system.

Some embodiments in accordance with the present disclosure can also be fabricated by way of a ceramic co-firing process. More particularly, an electrochemical or battery cell structure 1 such as that shown in FIG. 1 can be fabricated by creating sheets of ceramic powders suspended in an organic vehicle or medium, and spread into a thin layer by way of a tape casting process or procedure, and dried. A given sheet can have the consistency of leather or rubber, and can be further processed by cutting into an intended or desired shape, and forming vias therein at particular locations from one principal surface or side of the sheet to the other or opposite principal surface or side of the sheet. The vias can be filled with conductive material to provide electrical couplings between the sheet's principal surfaces. Furthermore, patterns of conductive material can be applied to one or both principal surfaces of selected sheets to provide electrically conductive patterns by which some or all conductive vias are electrically coupled together.

Sheets can be prepared corresponding to a given set of anode composition layers 20 and a given set of cathode composition layers 30, where each such sheet includes one or more types of ceramic anode material or cathode material powders therein. Each sheet has an intended or desired thickness, depending upon the final design requirements. An integrated anode-current collector structure 12 can include two sheets of tape cast anode material. A first sheet includes an anode current collector portion 25 applied to a first surface thereof (e.g., in accordance with a selectable or predetermined pattern), such as by way of screen printing. These sheets can be laminated together, such that the anode current collector portion 25 is internally carried approximately midway between two primary surfaces of the integrated anode-current collector structure 12. Similarly, an integrated cathode-current collector structure 14 can include two sheets of tape cast cathode material, a first sheet of which includes a cathode current collector portion 35 applied to a first surface thereof (e.g., in accordance with a selectable or predetermined pattern), such as by way of screen printing. These two sheets can be laminated together, such that the cathode current collector portion 35 is internally carried approximately midway between two primary surfaces of the integrated cathode-current collector structure 14.

A set of electrolyte layers or sheets 40 can be cast in a tape casting process to form a sheet of leather or rubber like consistency.

A precursor structure can be assembled by stacking anode-current collector structure(s) 12 and the integrated cathode-current collector structure(s) 14, with electrolyte sheets 40 disposed therebetween. Such a precursor structure can include, for instance, between 1-1000 alternating anode-current collector structures 12 and integrated cathode-current collector structures 14, each separated by an electrolyte sheet 40.

The precursor structure can be assembled or fabricated into a solid mass by way of a lamination process, which can include the application of pressure and heat to the precursor structure stack, after which a heat treatment process can occur in which the precursor structure as a solid mass is heated in a kiln to a temperature between approximately 400° C. and approximately 1500° C. for a time period between approximately 10 min. to approximately 50 hours.

Representative Dimensions and Material Selections

Depending upon embodiment details, the thickness of an integrated electrode-current collector structure 12, 14, 212, 214 can range between approximately 2 μm to approximately 1 mm; and the thickness of an electrolyte layer 40 can range between approximately 2 μm to approximately 500 m. For an integrated electrode-current collector structure 12, 14 containing an anode current collector portion 25 or cathode current collector portion 35 disposed therein, the thickness of the current collector portion 25, 35 can range between approximately 200 nm to approximately 50 μm; and the widths of individual patterned electron conductor elements such as wire elements can range between approximately 500 nm to a nearly-continuous layer across the entire area of the cell. In embodiments in which an integrated electrode-current collector structure 212, 214 is based on a 3D mesh current collector structure 100, the thickness of the 3D mesh current collector structure 100 can be the full thickness of its corresponding layer, or a fraction thereof, such as typically at least 30% of the layer thickness. The cells 104, gaps 114, or voids within a 3D mesh current collector structure 100 can have a cross-sectional dimension or diameter of between approximately 5 μm and approximately 500 μm.

Depending upon embodiment details, anode material powders suitable for use with particular embodiments of the present disclosure include carbon, graphite, and/or lithium titanium oxide. In certain embodiments, such anode powders can include or carry carbon based nanomaterials or nanostructures such as graphene, carbon nanotubes, or buckyballs. Cathode material powders suitable for use with particular embodiments of the present disclosure include powders of lithium cobalt oxide or lithium magnesium oxide. Suitable current collector materials include copper, nickel, silver, gold, palladium, or alloys thereof. Suitable electrolyte material powders include lithium lanthanum zirconium oxide. Suitable organic vehicles are well known in the art.

Electrochemical cell or battery cell structures fabricated in accordance with particular embodiments of the present disclosure can be expected to exhibit an energy density of approximately 300 Wh/Kg to approximately 600 Wh/Kg, and are well-suited for fabrication by way of high-volume automated manufacturing processes, including high-volume automated production processes by which different cell structures having distinct cell architectures can be readily produced in a flexible, highly customizable manner.

The description herein is provided to reveal particular representative embodiments in accordance with the present disclosure. It will be apparent that various modifications can be made to the embodiments described herein without departing from the scope of the present disclosure, or the claims included herewith.

1. An electrochemical cell structure comprising:
at least one electrochemical cell, each electrochemical cell comprising:
a plurality of integrated electrode-current collector structures, each integrated electrode
current collector structure carrying an electrode material therein, the plurality of integrated electrode-current collector structures including a first integrated electrode
current collector structure carrying a first electrode material therein, and an electrical or electrochemical counterpart second integrated electrode-current collector structure carrying a distinct second electrode material therein, the first and second integrated electrode-current collector structures comprising:
(a) an electrode material composition layer carrying the first electrode material or the second electrode material, respectively, the electrode material composition layer having a planar surface area greater than a thickness of the electrode material composition layer; and
a current collector layer comprising a current collector for the first integrated electrode-current collector structure or the second integrated electrode-current collector structure, respectively, the current collector layer disposed internal to and surrounded by the electrode composition layer;
or
(b) a 3D current collector material mesh structure comprising the current collector for the first integrated electrode-current collector structure or the second integrated electrode-current collector structure, respectively, the 3D current collector mesh structure having voids therein that provide a void volume fraction of the 3D current collector material mesh structure, wherein the first electrode material or the second electrode material, respectively, is distributed within or throughout the void volume fraction of the 3D current collector material mesh structure;
and
an electrolyte layer separating the first integrated electrode-current collector structure from its counterpart second integrated electrode-current collector structure and providing an ionic charge transport medium between the first integrated electrode-current collector structure and its counterpart second integrated electrode-current collector structure,
wherein the first integrated electrode-current collector structure comprises one of an integrated anode-current collector structure and an integrated cathode-current collector structure, and the second electrode-current collector structure comprises the other of the integrated anode-current collector structure and the integrated cathode-current collector structure.

2. The electrochemical cell structure of claim 1, wherein the electrochemical cell structure comprises a plurality of electrochemical cells stacked adjacent to each other.

3. The electrochemical cell structure of claim 2, wherein each of the first integrated electrode-current collector structure, the second integrated electrode-current collector structure, and the electrolyte layer comprises a 3D printed structure.

4. The electrochemical cell structure of claim 1, wherein the electrolyte layer comprises a ceramic electrolyte material.

5. The electrochemical cell structure of claim 1, wherein the first electrode material comprises a powder based anode material, and the second electrode material comprises a powder based cathode material.

6. The electrochemical cell structure of claim 1, wherein the electrolyte layer has a planar surface area that is greater than a thickness of the electrolyte layer.

7. The electrochemical cell structure of claim 1, wherein the plurality of integrated electrode-current collector structures comprises:
an integrated anode-current collector structure comprising an anode material composition layer having a thickness, and an anode current collector layer disposed internal to and surrounded by the thickness of the anode material composition layer; and
a counterpart integrated cathode-current collector structure comprising a cathode material composition layer having a thickness, and a cathode current collector layer disposed internal to and surrounded by the thickness of the cathode material composition layer.

8. The electrochemical cell structure of claim 7, wherein at least one of the anode current collector layer and the cathode current collector layer comprises a planar or quasi-2D layer of material.

9. The electrochemical cell structure of claim 8, wherein the planar or quasi-2D layer structure comprises a network of wire elements organized in accordance with a predetermined or selectable wire element pattern.

10. The electrochemical cell structure of claim 1, wherein the plurality of integrated electrode-current collector structures comprises a plurality of stacked electrochemical cells, each electrochemical cell within the stack comprising:
a 3D mesh integrated anode-current collector structure comprising a first 3D current collector material mesh structure having voids therein that provide a first void volume fraction, and having an anode material distributed within or throughout the first void volume fraction; and
a 3D mesh integrated cathode-current collector structure comprising a second 3D current collector material mesh structure having voids therein that provide a second void volume fraction, and having a cathode material distributed within or throughout the second void volume fraction.

11. The electrochemical cell structure of claim 10, wherein the 3D mesh integrated anode-current collector structure excludes the cathode material, and wherein 3D mesh integrated cathode-current collector structure excludes the anode material.

12. The electrochemical cell structure of claim 10, wherein each of the 3D mesh integrated anode-current collector structure and the 3D mesh integrated cathode current collector structure comprises a sinterable material.

13. A method for manufacturing a set of electrochemical cell structures, the method comprising manufacturing each electrochemical cell structure by way of:
producing a first integrated electrode-current collector structure carrying a first electrode material therein by way of a first additive manufacturing process;
producing an electrolyte layer disposed on an exposed surface of the first integrated electrode-current collector structure by way of a second additive manufacturing process; and
producing a second integrated electrode-current collector structure carrying a distinct second electrode material therein on an exposed surface of the electrolyte layer by way of a third additive manufacturing process,
wherein the first and second integrated electrode-current collector structures comprise:
(a) an electrode material composition layer carrying the first electrode material or the second electrode material, respectively, the electrode material composition layer having a planar surface area that is greater than a thickness of the electrode material composition layer; and
a current collector layer comprising a current collector for the first integrated electrode-current collector structure or the second integrated electrode-current collector structure, respectively, the current collector layer disposed internal to and surrounded by the electrode composition layer;
or
(b) a 3D current collector material mesh structure comprising the current collector for the first integrated electrode-current collector structure or the second integrated electrode-current collector structure, respectively, the 3D current collector mesh structure having voids therein that provide a void volume fraction of the 3D current collector material mesh structure, wherein the first electrode material or the second electrode material, respectively, is distributed within or throughout the void volume fraction of the 3D current collector material mesh structure,
wherein the electrolyte layer separates the first integrated electrode-current collector structure from its counterpart second integrated electrode-current collector structure, and the electrolyte layer provides an ionic charge transport medium between the first integrated electrode-current collector structure and its counterpart second integrated electrode-current collector structure.

14. The method of claim 13, wherein the second additive manufacturing process comprises fabricating an electrolyte layer on the exposed surface of the first integrated electrode-current collector structure, and wherein the electrolyte layer comprises a ceramic electrolyte material.

15. The method of claim 13, wherein each of the first, second, and third additive manufacturing processes comprise a 3D printing process.

16. The method of claim 13, wherein the first integrated electrode-current collector structure, the electrolyte layer, and the second integrated electrode-current collector structure each comprise a set of planar layers having a surface area greater than a thickness thereof.

17. The method of claim 13, wherein manufacturing each electrochemical cell structure comprises:
producing by way of the first additive manufacturing process an integrated anode-current collector structure comprising an anode material composition layer having a thickness, and an anode current collector layer disposed internal to and surrounded by the thickness of the anode material composition layer; and
producing by way of the third additive manufacturing process a counterpart integrated cathode-current collector structure comprising a cathode material composition layer having a thickness, and a cathode current collector layer disposed internal to and surrounded by the thickness of the cathode material composition layer.

18. The method of claim 17, wherein at least one of the first additive manufacturing process and the third additive manufacturing process comprises fabricating the current collector layer as quasi-2D layer of material.

19. The method of claim 17, wherein at least one of the first additive manufacturing process and the third additive manufacturing process comprises fabricating the current collector layer as quasi-2D network of current collector wire elements organized in accordance with a predetermined or selectable current collector wire element pattern.

20. The method of claim 16, wherein manufacturing each electrochemical cell structure comprises:
producing by way of the first additive manufacturing process a first 3D mesh structure comprising a first current collector material having voids therein that provide a first void volume fraction;
distributing an anode material within or throughout the first void volume fraction of the 3D mesh structure to thereby form a 3D mesh integrated anode-current collector structure;
producing by way of the third additive manufacturing process a second 3D mesh structure comprising a second 3D current collector material having voids therein that provide a second void volume fraction; and
distributing a cathode material within or throughout the second void volume fraction of the 3D mesh integrated cathode-current collector structure to thereby form a 3D mesh integrated cathode-current collector structure.

21. The method of claim 20, wherein the first void volume fraction is 50%-99.8% of the overall spatial volume of the first 3D mesh structure, and the second void volume fraction is 50%-99.8% of the overall spatial volume of the second 3D mesh structure.

22. The method of claim 20, wherein the 3D mesh integrated anode-current collector structure excludes the cathode material, and wherein the 3D mesh integrated cathode-current collector structure excludes the anode material.

23. The method of claim 20, wherein each of the 3D mesh integrated anode-current collector structure and the 3D mesh integrated cathode-current collector structure comprises a sinterable material.
